(19) United States
(12) Patent Application Publication
(10) Pub. No.: US 2011/0006773 A1
(43) Pub. Date: Jan. 13, 2011

(54) EM-Guided Drilling Relative to an Existing Borehole

(75) Inventor: Michael S. Bittar, Houston, TX (US)

Correspondence Address: KRUEGER ISELIN LLP (1391), P O BOX 1906, CYPRESS, TX, 77410-1906, US

(73) Assignee: Hilliburton Energy Services, Inc., Houston, TX (US)

(21) Appl. No.: 12/526,552

(22) PCT Filed: Jan. 18, 2008
(86) PCT No.: PCT/US08/51447

§ 371 Date: Sep. 26, 2010

(51) Int. Cl. G01V 3/12

(52) U.S. Cl. 324/333

(57) ABSTRACT

Parallel drilling systems and methods suitable for drilling wells for steam-assisted gravity drainage (SAGD). In some method embodiments, a tilted-antenna tool gathers azimuthally-sensitive electromagnetic signal measurements. Such measurements enable accurate measurement of inter-well distance and direction, thereby providing the necessary information for drilling accurately-spaced wells having reduced vulnerability to “short-circuits” that inhibit effective reservoir exploitation. In some other method embodiments, a tilted-antenna tool transmits azimuthally non-uniform signals as it rotates. The attenuation and azimuthal variation detected by one or more receivers enables accurate direction and distance determination. The transmitter and receiver antennas can in some cases be combined into a single tool, while in other cases the transmitters and receivers are placed in separate wells to increase detection range.

### BACKGROUND

The world depends on hydrocarbons to solve many of its energy needs. Consequently, oil field operators strive to produce and sell hydrocarbons as efficiently as possible. Much of the easily obtainable oil has already been produced, so new techniques are being developed to extract less accessible hydrocarbons. One such technique is steam-assisted gravity drainage (“SAGD”) as described in U.S. Pat. No. 6,257,334, “Steam-Assisted Gravity Drainage Heavy Oil Recovery Process”. SAGD uses a pair of vertically-spaced, horizontal wells about less than 10 meters apart.

In operation, the upper well is used to inject steam into the formation. The steam heats the heavy oil, thereby increasing its mobility. The warm oil (and condensed steam) drains into the lower well and flows to the surface. A throttling technique is used to keep the lower well fully immersed in liquid, thereby “trapping” the steam in the formation. If the liquid level falls too low, the steam flows directly from the upper well to the lower well, reducing the heating efficiency and inhibiting production of the heavy oil. Such a direct flow (termed a “short circuit”) greatly reduces the pressure gradient that drives fluid into the lower well.

Short circuit vulnerability can be reduced by carefully maintaining the inter-well spacing, i.e., by making the wells as parallel as possible. Points where the inter-well spacing is smaller than average provide lower resistance to short circuit flows. In percentage terms, the significance of variations in borehole spacing is reduced at larger inter-well spacings. Hence, in the absence of precision drilling techniques, the inter-well spacing is kept larger than would otherwise be desirable to reduce short circuit vulnerability.

### BRIEF DESCRIPTION OF THE DRAWINGS

A better understanding of the various disclosed embodiments can be obtained when the following detailed description is considered in conjunction with the accompanying drawings, in which:

FIG. 1 shows an illustrative drilling environment in which electromagnetically-guided drilling may be employed;

FIG. 2 shows an illustrative reservoir in which steam-assisted gravity drainage (SAGD) is employed;

FIG. 3 shows a coordinate system for specifying antenna tilt;

FIG. 4 shows a borehole cross-section divided into azimuthal sectors;

FIG. 5 shows an illustrative electromagnetic logging tool suitable for guided drilling;

FIG. 6 shows an illustrative graph of phase shift as a function of formation resistivity;

FIG. 7A shows a new borehole path relative to an existing borehole;

FIG. 7B shows a modeled range of resistivity measurements;

FIG. 7C shows a modeled geosteering signal;

FIGS. 7D-7F show modeled geosteering signals for different frequencies and antenna spacings; and

FIG. 8 shows a flow diagram of an illustrative EM-guided drilling method.

While the invention is susceptible to various modifications and alternative forms, specific embodiments thereof are shown by way of example in the drawings and will herein be described in detail. It should be understood, however, that the drawings and detailed description are not intended to limit the invention to the particular form disclosed, but on the contrary, the intention is to cover all modifications, equivalents and alternatives falling within the spirit and scope of the present invention as defined by the appended claims.

### DETAILED DESCRIPTION

The issues identified in the background are at least partly addressed by the use of electromagnetically-guided (EM-guided) drilling relative to an existing borehole. A tilted-antenna tool provides azimuthally-sensitive measurements of resistivity that can be used to detect distance and direction to an existing borehole. Such measurements can be made at multiple investigation depths to provide unprecedented distance measurement accuracy at ranges up to six meters or more from a nearby borehole. (Depending on the steering mechanism, the distance can be maintained constant to within 0.5 meters.) With such measurements, guided drilling of closely-spaced wells can be accomplished without undue vulnerability to short circuits.

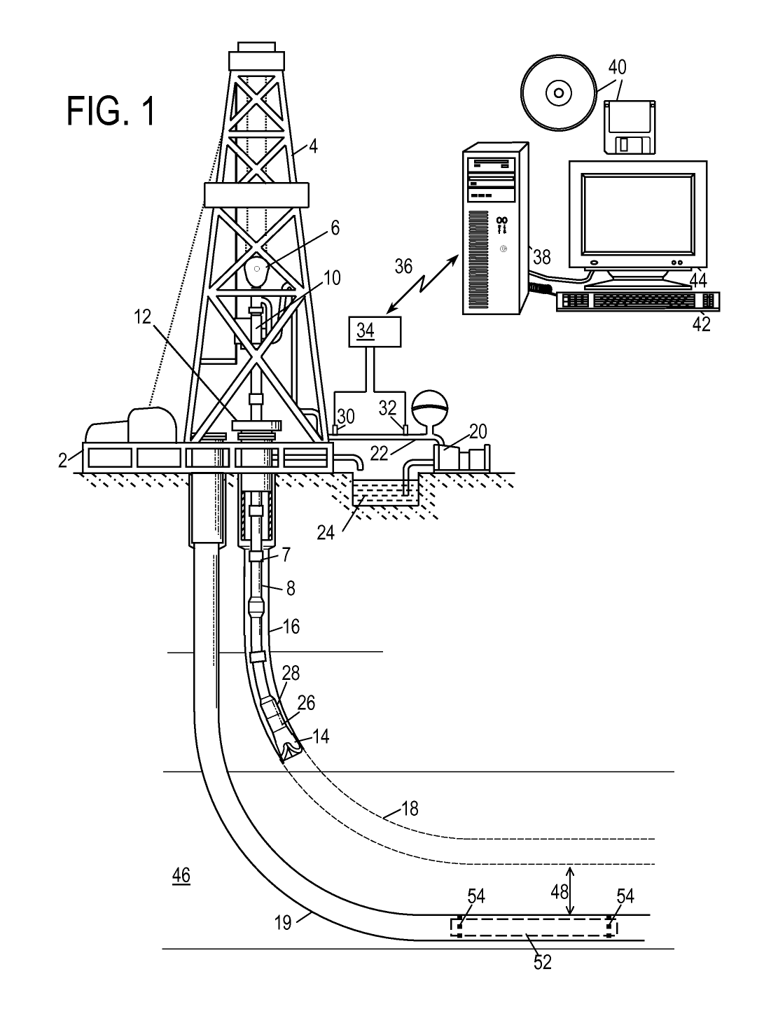

The disclosed EM-guidance systems and methods are best understood in the context of the larger systems in which they operate. Accordingly, an illustrative geosteering environment is shown in FIG. 1. A drilling platform 2 supports a derrick 4 having a traveling block 6 for raising and lowering a drill string 8. A top drive 10 supports and rotates the drill string 8 as it is lowered through the wellhead 12. A drill bit 14 is driven by a downhole motor and/or rotation of the drill string 8. As bit 14 rotates, it creates a borehole 16 that passes through various formations.

The drill bit 14 is just one piece of a bottom-hole assembly that includes one or more drill collars (thick-walled steel pipe) to provide weight and rigidity to aid the drilling process. Some of these drill collars include logging instruments to gather measurements of various drilling parameters such as position, orientation, weight-on-bit, borehole diameter, etc. The tool orientation may be specified in terms of a tool face angle (rotational orientation), an inclination angle (the slope), and compass direction, each of which can be derived from measurements by magnetometers, inclinometers, and/or accelerometers, though other sensor types such as gyroscopes may alternatively be used. In one specific embodiment, the tool includes a 3-axis fluxgate magnetometer and a 3-axis accelerometer. As is known in the art, the combination of those two sensor systems enables the measurement of the tool face angle, inclination angle, and compass direction. In some embodiments, the tool face and hole inclination angles are calculated from the accelerometer sensor output. The magnetometer sensor outputs are used to calculate the compass direction.

The bottom-hole assembly further includes a tool 26 to gather measurements of formation properties from which nearby borehole detection signals can be derived. Using these measurements in combination with the tool orientation measurements, the driller can steer the drill bit 14 along a desired path 18 in formation 46 using any one of various suitable directional drilling systems, including steering vanes, a “bent sub”, and a rotary steerable system to steer the drill bit along a desired path 18 parallel to an existing borehole. For precision steering, the steering vanes may be the most desirable steering mechanism. The steering mechanism can be alternatively controlled downhole, with a downhole controller programmed to follow the existing borehole 19 at a predetermined distance 48 and position (e.g., directly above or below the existing borehole).

A pump 20 circulates drilling fluid through a feed pipe 22 to top drive 10, downhole through the interior of drill string 8, through orifices in drill bit 14, back to the surface via the annulus around drill string 8, and into a retention pit 24. The drilling fluid transports cuttings from the borehole into the pit 24 and aids in maintaining the borehole integrity. Moreover, a telemetry sub 28 coupled to the downhole tools 26 can transmit telemetry data to the surface via mud pulse telemetry. A transmitter in the telemetry sub 28 modulates a resistance to drilling fluid flow to generate pressure pulses that propagate along the fluid stream at the speed of sound to the surface. One or more pressure transducers 30, 32 convert the pressure signal into electrical signal(s) for a signal digitizer 34. Note that other forms of telemetry exist and may be used to communicate signals from downhole to the digitizer. Such telemetry may employ acoustic telemetry, electromagnetic telemetry, or telemetry via wired drillpipe.

The digitizer 34 supplies a digital form of the telemetry signals via a communications link 36 to a computer 38 or some other form of a data processing device. Computer 38 operates in accordance with software (which may be stored on information storage media 40) and user input via an input device 42 to process and decode the received signals. The resulting telemetry data may be further analyzed and processed by computer 38 to generate a display of useful information on a computer monitor 44 or some other form of a display device. For example, a driller could employ this system to obtain and monitor drilling parameters, formation properties, and the path of the borehole relative to the existing borehole 19 and any detected formation boundaries. A downlink channel can then be used to transmit steering commands from the surface to the bottom-hole assembly.

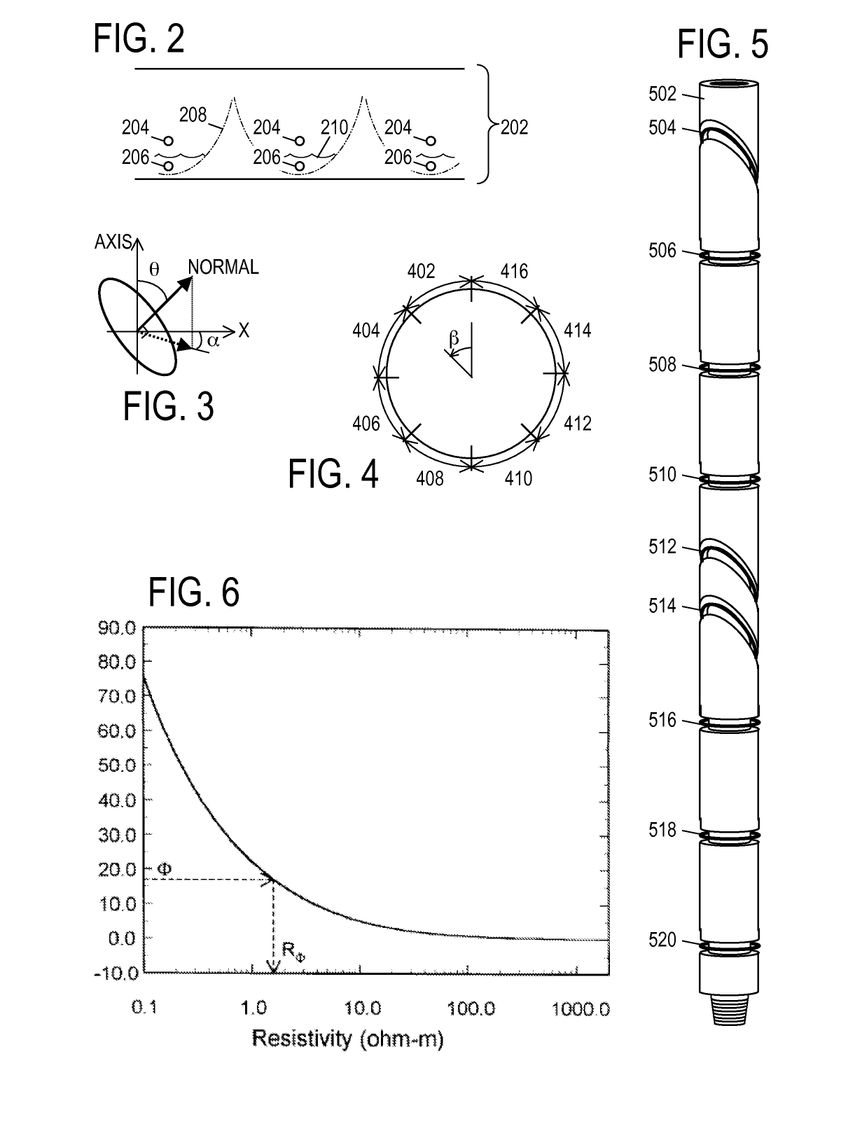

With such a drilling system it becomes possible to drill an arrangement of boreholes that enable efficient production of heavy oils from a formation using a steam-assisted gravity drainage (SAGD) technique. FIG. 2 shows a formation 202 having vertically-spaced pairs of boreholes (shown end-on in this view), each pair consisting of an injection well 204 and a production well 206. Steam is injected into the formation where it condenses, heating the heavy oil around and above the wells. With its mobility increased, the heavy oil drains downward, along with the condensate to form a liquid pool 210 that is produced via well 206. The unheated heavy oil eventually acquires the profile 208, often necessitating the use of multiple well pairs to efficiently access the oil reserves. The ability to routinely drill precisely-spaced boreholes is expected to greatly enhance the value of such heavy oil reserves.

In at least some embodiments, the nearby borehole detection tool 26 employs tilted antennas for electromagnetic resistivity measurements such as those disclosed by Michael Bittar in U.S. Pat. No. 7,265,552. As shown in FIG. 3, the orientation of such tilted antennas can be specified in terms of a tilt angle θ and a rotational angle α. The tilt angle is the angle between the tool axis and the magnetic moment of the loop antenna. The rotational angle α is the angle between the tool face scribe line and the projection of the normal vector. As the tool rotates, the tilted antenna(s) gain measurement sensitivity in different azimuthal directions from the borehole, and these measurements can be made as a function of the azimuthal angle. FIG. 4 shows a borehole circumference divided into azimuthal sectors 402-416, corresponding to ranges of azimuthal angles. The azimuthal angle β is defined relative to the “high-side” of the borehole (or, in substantially vertical wells, relative to the north-side of the borehole). When the tool is centered in the borehole, the azimuthal angle β preferably corresponds to the position of the tool face scribe line. In some embodiments, angular corrections are applied to the rotational orientations of de-centralized tools when associating measurements with an azimuthal sector. Though eight sectors are shown in the figure, the actual number of sectors may vary between 4 and the highest resolution the tool will support.

Referring now to FIG. 5, an illustrative borehole detection tool 502 is shown. The tool 502 is provided with one or more regions of reduced diameter for suspending a wire coil. The wire coil is placed in the region and spaced away from the tool surface by a constant distance. To mechanically support and protect the coil, a non-conductive filler material (not shown) such as epoxy, rubber, fiberglass, or ceramics may be used to fill in the reduced diameter regions. The transmitter and receiver coils may comprise as little as one loop of wire, although more loops may provide additional signal power. The distance between the coils and the tool surface is preferably in the range from 1/16 inch to ¾ inch, but may be larger.

The illustrated tool 502 has six coaxial transmitters 506 (T5), 508 (T3), 510 (T1), 516 (T2), 518 (T4), and 520 (T6), meaning that the axes of these transmitters coincide with the longitudinal axis of the tool. In addition, tool 502 has three tilted receiver antennas 504 (R3), 512 (R1), and 514 (R2). The term “tilted” indicates that the magnetic moment of the coil is not parallel to the longitudinal tool axis. The spacing of the antennas may be stated in terms of a length parameter x, which in some embodiments is about 16 inches. Measuring along the longitudinal axis from a midpoint between the centers of receiver antennas 512 and 514, transmitters 510 and 516 are located at ±1x, transmitters 508 and 518 are located at ±2x, and transmitters 506 and 520 are located at ±3x. The receiver antennas 512 and 514 may be located at ±x/4. In addition, a receiver antenna 504 may be located at plus or minus 4x.

The length parameter and spacing coefficients may be varied as desired to provide greater or lesser depths of investigation, higher spatial resolution, or higher signal to noise ratio. However, with the illustrated spacing, symmetric resistivity measurements can be made with 1x, 2x, and 3x spacing between the tilted receiver antenna pair 512, 514, and the respective transmitter pairs 510 (T1), 516 (T2); 508 (T3), 518 (T4); and 506 (T5), 520 (T6). In addition, asymmetric resistivity measurements can be made with 1x, 2x, 3x, 5x, 6x, and 7x spacing between the tilted receiver antenna 504 and the respective transmitters 506, 508, 510, 516, 518, and 520. This spacing configuration provides tool 502 with some versatility, enabling it to perform deep (but asymmetric) measurements for nearby borehole detection and symmetric measurements for accurate azimuthal resistivity determination.

In some contemplated embodiments, the transmitters may be tilted and the receivers may be coaxial, while in other embodiments, both the transmitters and receivers are tilted, though preferably the transmitter and receiver tilt angles are different. Moreover, the roles of transmitter and receiver may be interchanged while preserving the usefulness of the measurements made by the tool. In operation, each of the transmitters is energized in turn, and the phase and amplitude of the resulting voltage induced in each of the receiver coils are measured. From these measurements, or a combination of these measurements, the formation resistivity can be determined as a function of azimuthal angle and radial distance. Moreover, the distance and direction to nearby boreholes can be measured.

For asymmetric resistivity measurements, receiver 504 detects a signal responsive to the firing of each transmitter. The tool 502 measures the phase shift and attenuation of the received signal relative to the phase and amplitude of the transmit signal. The larger transmitter-receiver spacings provide measurements over larger formation volumes, yielding deeper depths of investigation. Tool 502 can also employ multiple transmit signal frequencies to further increase the number of depths of investigation. FIG. 6 shows an illustrative phase shift dependence on formation resistivity. The signal attenuation exhibits a similar dependence. With attenuation and phase shift measurements at multiple azimuthal orientations and multiple depths of investigation, tool 502 can compile a three-dimensional view of the resistivity profile of the formation around the borehole as the drilling progresses.

For symmetric resistivity measurements, receivers 512, 514 each detect signals responsive to the firing of each transmitter. The tool 502 measures the phase shift and attenuation between the received signals and combines the measurements from the equally-spaced transmitters to provide robust compensation for temperature drift and other electronic circuit imperfections. The degree of compensation can be measured and, if desired, applied to the asymmetric resistivity measurements. Otherwise, the analysis and usage of the symmetric measurements is similar to the asymmetric measurements.

In the illustrated embodiment of FIG. 5, the receiver coils are tilted with a 45° angle between the normal and the tool axis. Angles other than 45° may be employed, and in some contemplated embodiments, the receiver coils are tilted at unequal angles or are tilted in different azimuthal directions. The tool 502 is rotated during the drilling process, so that resistivity measurements can be made with the tilted coils oriented in different azimuthal directions. These measurements may be correlated with tool orientation measurements to enable detection of borehole distances and directions.

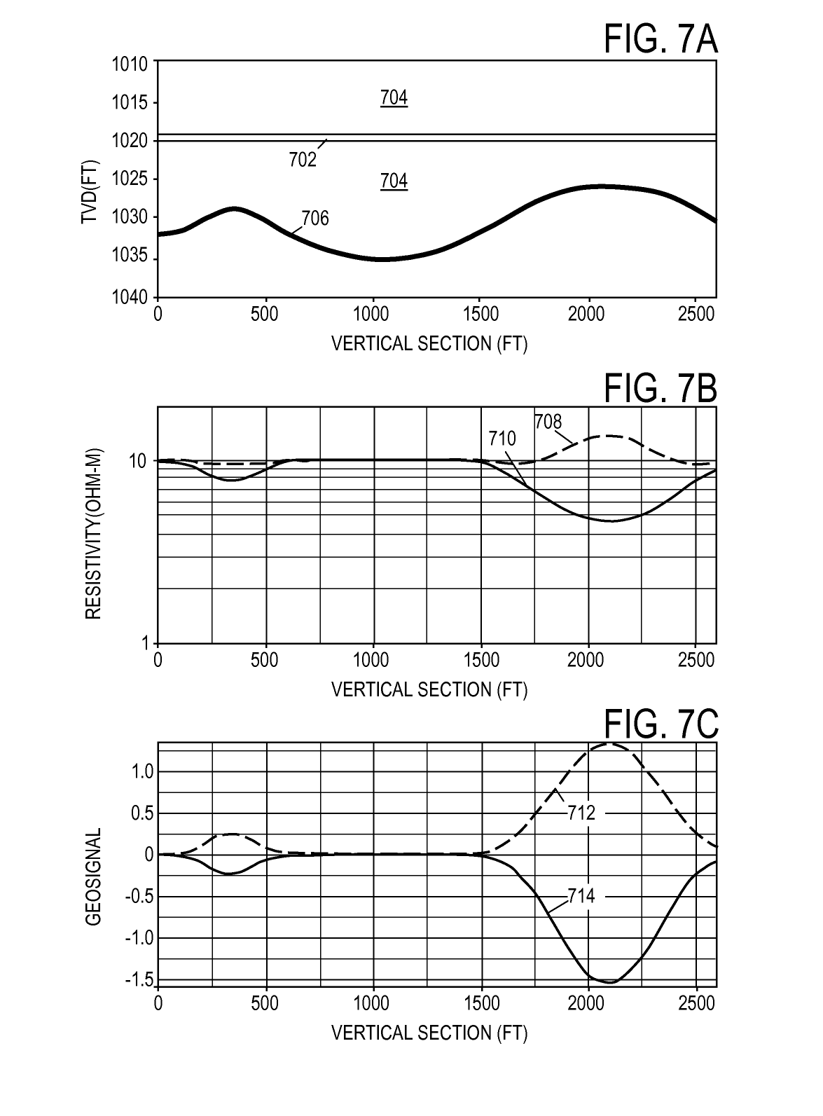

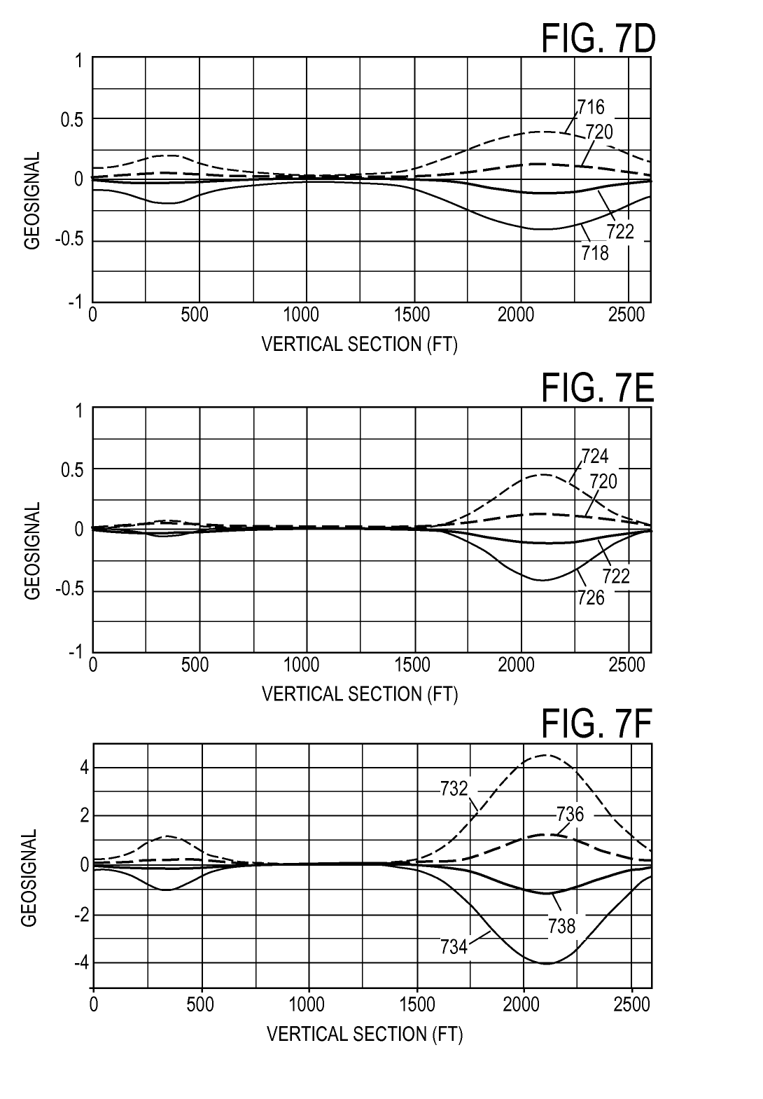

FIG. 7A shows a hypothetical 12 inch borehole 702 passing horizontally through a formation 704 at a depth of 1020 feet. The formation is assumed to have a resistivity of 10 ohm-m, while the borehole is assumed to have a resistivity of less than 1 ohm-m. Simulations have been run for a tilted-antenna tool passing along a nearby path 706 through the formation. Path 706 has an average depth of 1030 feet, but it has a first deviation of +2 and −2 feet, followed by a deviation of +5 and −5 feet. With a transmitter-receiver spacing of 112 inches and a signal frequency of 125 kHz, the resulting formation resistivity measurements are shown in FIG. 7B. Curve 710 shows the resistivity measured while the tool is rotated toward borehole 702, and curve 708 shows the resistivity measured at the opposite orientation. In this hypothetical example, the detection range is about 10 feet. When the tool moves beyond this distance, the borehole is not detected. However, when the distance falls below this value the distance and direction of borehole 702 is readily determinable.

FIG. 7C shows a geosteering signal (“geosignal”) calculated by taking a difference between the azimuthal attenuation measurement (in dB) and an average attenuation measurement (in dB) over all azimuths. Curve 714 shows the geosignal when the tool is oriented toward borehole 702 and curve 712 shows the geosignal for the opposite orientation. When the tool is within 10 feet, the geosignal varies with tool rotation, reaching a minimum when the tool is oriented towards the nearby borehole. The magnitude of the variation is indicative of the distance to the borehole. Greater range may be expected in formations having higher resistivity, if longer transmitter-receiver antenna spacings are employed, and/or if lower frequencies are employed. Greater sensitivity to distance is expected with shorter transmitter-receiver antenna spacings and/or higher frequencies. Thus it is desirable to have variable spacing and/or frequencies. Note that most reservoirs of interest are expected to have much higher formation resistivities. More detail regarding suitable methods for calculating a geosteering signal can be found in U.S. patent application Ser. No. ______ (Atty Dkt 1391-681.00).

The effects different tool parameters on the geosteering signal are illustrated in FIGS. 7D-7F, using the same hypothetical configuration of FIG. 7A. In FIG. 7D, curves 716 and 718 are attenuation-based geosteering signals obtained using an 112-inch transmitter-receiver spacing with a 125 kHz signal frequency. Curve 718 is obtained when the tool is oriented toward borehole 702, and curve 716 is obtained when the tool is oriented away from the borehole. These curves can be compared with curves 720 and 722, which are obtained with the same frequency, but with a 48-inch transmitter-receiver spacing, showing the greater range of the longer-spaced antenna configuration.

In FIG. 7E, curves 720 and 722 are repeated for comparison with curves 724 and 726, which are obtained with a 48-inch transmitter-receiver spacing and a 500 kHz signal frequency. Clearly, the higher signal frequency also provides an increased detection range. In this and the previous figure, the geosignal curves are attenuation-based, i.e., determined by subtracting the average attenuation from the azimuthally-sensitive attenuation measurement. In FIG. 7F, however, the geosignal is phase-based, i.e., determined by subtracting the average phase shift from the azimuthally-sensitive phase shift measurement. Curves 732 and 734 are obtained with a 112-inch spacing and a signal frequency of 125 kHz. Curves 736 and 738 are obtained with the same signal frequency, but a 48-inch spacing. In both cases, the lower curve is obtained when the tool is oriented toward the nearby borehole, and the upper curve is obtained when the tool is oriented away.

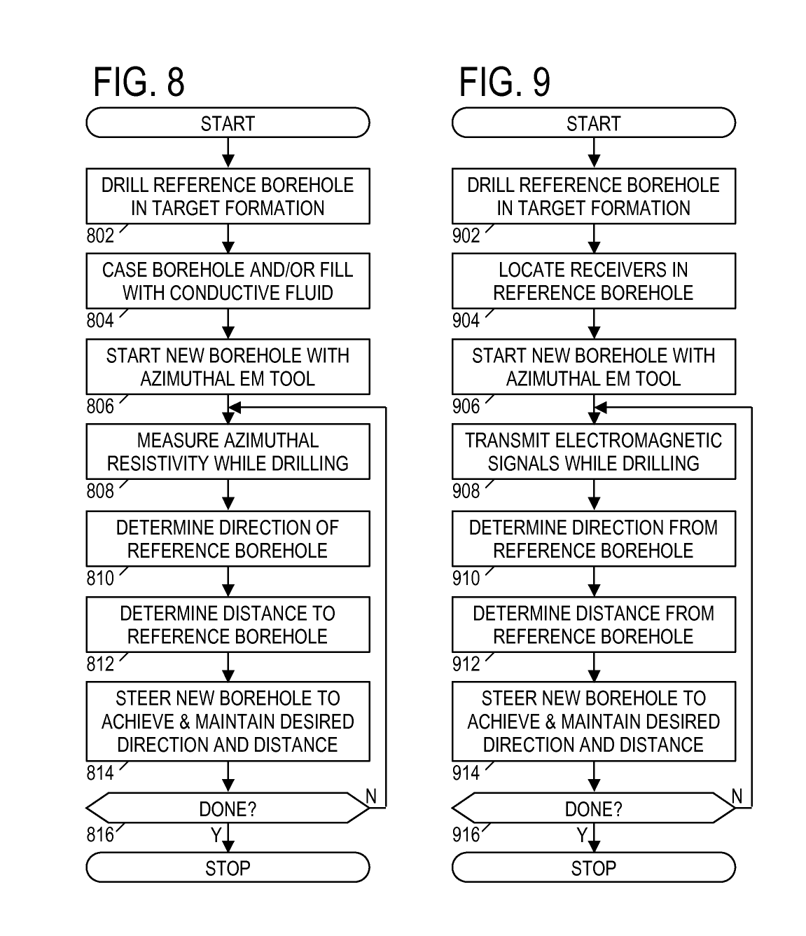

FIG. 8 is a flowchart of an illustrative method for drilling closely-spaced parallel boreholes. Beginning with block 802, a driller drills the initial (“reference”) borehole in the target formation. Much of the time, the initial borehole will be placed as near the bottom of the oil-bearing bed as feasible, and will later be used as the producing borehole. Though deviations from a straight path may be provided to follow the bed boundary, the path of the reference borehole in most applications will be maintained as straight as possible to simplify parallel drilling.

In block 804, the reference borehole is given a contrasting resistivity from the surrounding formation. Because oil-producing formations tend to be highly resistive, this operation may involve lining the reference borehole with an electrically-conductive well casing. As an alternative, the reference borehole may be filled with a conductive fluid such as a water-based drilling fluid having mobile ions.

In block 806, a driller starts drilling a new borehole with a drill string that includes an azimuthally-sensitive electromagnetic tool and a steering mechanism for controlling drilling direction. The new borehole may be a separate well as shown in FIG. 1, or it may be a branch well initiated from part way along the initial well. In block 808, the tool gathers azimuthally-sensitive measurements indicative of formation resistivity. These measurements can be used directly or indirectly to determine the direction of the reference borehole in block 810. In some embodiments, the direction is the azimuthal angle associated with the minimum resistivity measurement or with an extremum in the geosteering signal. Such knowledge enables ready determination of the desired drilling direction if an increase or decrease in inter-well spacing is desired.

In block 812, the distance to the reference borehole is determined. This distance may be determined as a function of average formation resistivity and the magnitude of the sinusoidal variation that the measurement exhibits versus azimuthal angle. The tool's engineers may calibrate the tool and determine a lookup table from which distance measurements can be determined. Alternatively, a more complete processing of the three-dimensional dependence of resistivity may be employed to determine the distance to the reference borehole. However, in some embodiments, the magnitude of the geosteering signal may be employed as a rough distance indicator, and the bit may be steered to maintain this magnitude at a relatively constant value rather than determining an absolute distance measurement.

In block 814, the drilling direction is adjusted in response to the direction and distance determinations to keep the inter-well distance and orientation as consistent as possible. In some embodiments, a downhole processor in the bottom hole assembly performs an automatic determination of direction and distance and automatically adjusts the steering mechanism to establish a constant vertical spacing which can be set and adjusted from the surface. In other embodiments, the driller monitors the direction and distance measurements at the surface and sends steering commands to the bottom hole assembly. As long as the drilling continues, block 816 indicates that blocks 808-814 of the process are repeated.

FIG. 9 is a flowchart of an alternative method for drilling closely-spaced parallel boreholes. As before, a driller begins by drilling a reference borehole in the target formation (block 902). In block 904, an array of receivers is placed in the reference borehole. (Referring momentarily to FIG. 1, a receiver tool 52 is located in reference borehole 19. The illustrated tool 52 includes two co-axial antennas 54, but additional receivers may be employed.) In some embodiments, the receiver array is essentially fixed and non-rotating. In such embodiments, the receiver spacing is chosen to ensure that at least one receiver is able to detect signals from the transmitter at all points in the region of interest, and the extent of the receiver array is designed to cover the length of the reference borehole in the region of interest. In other embodiments, the receiver array is moved along the reference borehole as the drilling progresses. In such embodiments, the extent of the receiver array can be substantially reduced.

In block 906, the driller starts drilling a new borehole with a drill string that includes at least one tilted-antenna transmitter and a steering mechanism for controlling drilling direction. In block 908, the tool transmits electromagnetic signals with an azimuthally-varying directivity as the tool rotates. The tool orientation information may be encoded into the transmit signals, or alternatively communicated to the surface. Where multiple transmit antennas are employed, the transmitters may operate at different frequencies and/or fire at different times. If desired, transmitter identification information may also be encoded into the transmit signal.

In block 910, at least one of the receive antennas in the reference borehole detects the transmit signal(s) and measures amplitude variation and phase shift as a function of time. The timing of the sinusoidal variation can be combined with transmitter orientation information (either at the surface or using the information encoded into the transmit signal) to determine the relative direction between the transmitter and the receivers in the reference borehole. Moreover, if multiple receive antennas detect the signal, array processing techniques may be used to triangulate the direction of the transmitter relative to the receiver array. Some embodiments include azimuthally-sensitive receive antennas to improve direction-detection capability. For example, a triad of linearly-independent receive antennas can be located at each receiving position in the receiver array.

In block 912, the distance between the transmitter and the receiver array in the reference borehole is determined. This distance may be determined as a function of average signal strength and the magnitude of the sinusoidal variation that the measurement exhibits versus azimuthal angle. Alternatively, a more complete processing of the signals from each of the transmitters to each of the receivers may be employed to determine the distance to the reference borehole.

In block 914, the drilling direction is adjusted in response to the direction and distance determinations to keep the inter-well distance and orientation as consistent as possible. In some embodiments, the driller monitors the direction and distance measurements at the surface and sends steering commands to the bottom hole assembly. As long as the drilling continues, block 916 indicates that blocks 908-914 of the process are repeated. Re-positioning of the receiver array within the reference borehole may be needed periodically.

Note that the roles of transmitters and receivers can be interchanged. In some embodiments, a set of two or more transmitters is located in the reference borehole and a set of azimuthally-sensitive receive antennas is provided in the bottom hole assembly. In this alternative configuration, the downhole processor may be programmed with limited autosteering capability based on the measurements of distance and direction from the reference borehole as represented by a line connecting the transmitters. Autosteering can be performed using any standard feedback technique for minimizing the error between programmed and measured distance and direction values, subject to the constraints imposed by the steering dynamics of the drillstring.

In many situations, it may not be necessary to perform explicit distance and direction calculations. For example, the deep resistivity or geosignal values may be converted to pixel colors or intensities and displayed as a function of borehole azimuth and distance along the borehole axis. Assuming the reference borehole is within detection range, the reference borehole will appear as a bright (or, if preferred, a dark) band in the image. The color or brightness of the band indicates the distance to the reference borehole, and the position of the band indicates the direction to the reference borehole. Thus, by viewing such an image, a driller can determine in a very intuitive manner whether the new borehole is drifting from the desired course and he or she can quickly initiate corrective action. For example, if the band becomes dimmer, the driller can steer towards the reference borehole. Conversely, if the band increases in brightness, the driller can steer away from the reference borehole. If the band deviates from its desired position directly above or below the existing borehole, the driller can steer laterally to re-establish the desired directional relationship between the boreholes.

Numerous variations and modifications will become apparent to those skilled in the art once the above disclosure is fully appreciated. It is intended that the following claims be interpreted to embrace all such variations and modifications.

What is claimed is:

1. A parallel drilling method that comprises:
gathering azimuthally-sensitive measurements of electromagnetic signals while drilling a new borehole near an existing borehole; and
steering a drill string along a path at a substantially constant distance from the existing borehole.

2. The method of claim 1, wherein the distance is less than 10 meters and constant to within +/−0.5 meters.

3. The method of claim 1, wherein the new borehole is positioned vertically above or below the existing borehole.

4. The method of claim 1, wherein the existing borehole is cased with a conductive casing.

5. The method of claim 1, wherein the existing borehole is filled with a conductive fluid.

6. The method of claim 1, wherein the drill string includes a tool having at least one tilted antenna in the bottom hole assembly.

7. The method of claim 1, wherein the drill string includes both a transmit and receive antennas for making the azimuthally-sensitive measurements.

8. The method of claim 7, wherein the azimuthally-sensitive measurements are indicative of a three-dimensional resistivity profile around the new borehole.

9. The method of claim 7, wherein the azimuthally-sensitive measurements are geosignals indicative of an azimuthal direction towards a conductive object.

10. The method of claim 1, wherein said steering includes:
processing the azimuthally-sensitive measurements downhole to determine control signals for steering the drill string in a manner that minimizes a difference between measured and programmed distance values.

11. A parallel drilling system that comprises:
a steerable drill string that includes a tool having at least one tilted antenna,
wherein the tool gathers measurements for determining distance to an existing borehole.

12. The system of claim 11, wherein the drill string includes a downhole processor that determines steering control signals to direct the drill string along a path parallel to the existing borehole.

13. The system of claim 11, wherein tool determines a signal indicative of a direction to the existing borehole.

14. The system of claim 11, wherein the measurements include measurements of signal attenuation as a function of azimuthal angle.

15. The system of claim 11, wherein the measurements include measurements of signal phase shift as a function of azimuthal angle.

16. The system of claim 11, further including an array of at least two transmitters in the existing borehole.

17. The system of claim 11, further comprising a surface computer that enables a driller to monitor said distance and responsively steer the drill string along a path at a constant distance and direction from the existing borehole.

18. A parallel drilling method that comprises:
transmitting an azimuthally non-uniform electromagnetic signal from a source in a drill string while creating a new borehole; and
detecting the signal with at least two receivers in an existing borehole to determine distance from the existing borehole to the source.

19. The method of claim 18, further comprising steering the drill string to direct the new borehole along a path that parallels the existing borehole.

20. The method of claim 18, wherein the source includes at least one tilted transmitter antenna.

21. The method of claim 20, wherein the tilted transmitter antenna rotates to transmit the signal in different azimuthal directions.

22. The method of claim 21, wherein the signal includes information regarding the azimuthal orientation of the source.

23. The method of claim 18, further comprising determining a direction between the existing borehole and the source.

24. The method of claim 23, further comprising communicating the distance and direction measurement to a surface computer.

25. The method of claim 24, further comprising displaying a representation of the existing borehole relative to the new borehole to enable the driller to steer the new borehole parallel to the existing borehole.
